(19) United States
(12) Patent Application Publication
(10) Pub. No.: US 2024/0194971 A1
(43) Pub. Date: Jun. 13, 2024

(54) HEAT MANAGEMENT DEVICE FOR AN ELECTRICAL AND/OR ELECTRONIC COMPONENT

(71) Applicant: VALEO SYSTEMES THERMIQUES, La Verriere (FR)

(72) Inventors: Cedric DE VAULX, La Verriere (FR); Kamel AZZOUZ, La Verriere (FR); Jeremy BLANDIN, La Verriere (FR); Yolanda BRAVO, La Verriere (FR)

(73) Assignee: VALEO SYSTEMES THERMIQUES, La Verriere (FR)

(21) Appl. No.: 18/554,016

(22) PCT Filed: Apr. 7, 2022
(86) PCT No.: PCT/EP2022/059192

§ 371 Date: Oct. 5, 2023

(30) Foreign Application Priority Data
Apr. 7, 2021 (FR) FR2103559

(51) Int. Cl. H01M 10/653; H01M 50/213; H01M 50/224; H01M 50/289

(52) U.S. Cl. CPC H01M 10/653; H01M 50/213; H01M 50/224; H01M 50/289

(57) ABSTRACT

The invention relates to a heat management device (2) for at least one electrical and/or electronic component (4) for an electrical storage device (1), comprising at least one thermal regulation means (8), the heat management device (2) being characterized in that it further comprises a rigid supporting part (6) comprising at least one cavity (10) for receiving the at least one electrical and/or electronic component (4), the rigid supporting part (6) being made of a material with high thermal conductivity.

### TECHNICAL FIELD

The present invention concerns a heat management device for an electrical and/or electronic component, for example a battery element suitable for use in an electrical storage device, in particular for a motor vehicle.

Electrical and/or electronic components of an electronic system to which the present invention can relate can consist equally of computer servers and components of electrical energy storage systems, in particular batteries, for motor vehicles.

### BACKGROUND OF THE INVENTION

In the field of motor vehicles, electrical storage devices otherwise known as batteries can be used within vehicles to supply various functions of said vehicles. Electrical storage devices normally used comprise at least one battery cell intended to install and/or provide electrical energy. The function of these electrical storage devices causes an increase in their temperature. In fact during operation, both for provision of electrical energy and to be recharged, the battery cell releases a large quantity of heat, the effect of which is to increase the temperature of the electrical storage device and in the long-term can reduce the performance of and/or damage the electrical storage device.

Thus to control the temperature of electrical storage devices at least during their operation, they can be associated with heat management devices. The heat management devices can for example reduce the temperature of the battery cell of the electrical storage device during its operation. In the case where the function of electrical storage devices is to supply a low-voltage network associated with electrical accessories of the vehicle, the problems of cooling are simple to solve in particular since said electrical storage devices have relatively small volumes.

However, in the case where electrical storage devices are used in the context of electrical or hybrid vehicles, in particular for their electric propulsion, said electrical storage devices have large volumes and the means of cooling these electrical storage devices, for electric or hybrid cars, are more complex to implement.

The invention forms part of this context and has the objective of providing an alternative for heat management devices for electronic systems containing electrical and/or electronic components, whether these are computer servers, batteries of motor vehicles or any other type of electronic system having components which are liable to heat up during their operation or while they are being charged, by proposing a heat management device which is able to bring the electrical or electronic component to the desired temperature in a defined time. The aim is therefore to improve the performance of the heat management devices used to regulate the temperature of electronic systems, in particular when the latter have a large volume, for example for batteries used for propulsion of an electric or hybrid vehicle.

### BRIEF SUMMARY OF THE INVENTION

The invention therefore relates to a heat management device for at least one electrical and/or electronic component comprising at least one thermal regulation component, the heat management device being characterized in that it further comprises a rigid supporting part comprising at least one cavity for receiving the at least one electrical and/or electronic component, the rigid supporting part being made of a material with high thermal conductivity.

The heat management device can be used in particular for an electrical and/or electronic component of the battery cell type of an electrical storage device, otherwise known as a battery, in a vehicle. The function of the heat management device is to regulate the temperature of the battery cell, for example by cooling it during operation, or by preheating the battery during start-up.

The function of the rigid supporting part is to form an intermediate piece between the heat management component, formed at least partly by the channel, and the electrical and/or electronic component housed in the receiving cavity, so that the positioning of the electrical and/or electronic components relative to one another can be ensured and the heat and/or cold can be transmitted by diffusion from the heat management component to each of the electrical and/or electronic components. Such a diffusion of the heat and/or cold generated by the thermal regulation component takes place by means of the thermally conductive material making up the rigid supporting part.

In other words, the rigid supporting part allows the heat and/or cold produced by the thermal regulation component to be diffused into the at least one receiving cavity of the rigid supporting part designed to house the electrical and/or electronic component. According to the invention, the rigid supporting part is made of a material with high thermal conductivity which can specifically act as a heat diffuser for the purpose of either heating or cooling of the electrical and/or electronic components. A material with high thermal conductivity means that, at 20° C., the thermal conductivity of the selected material is at least 120 W/m/K. In the case of a rigid supporting part produced with the composition of multiple materials, it is understood that the thermal conductivity value should be considered as the mean of the thermal conductivity values of each material.

According to a feature of the invention, the high thermal conductivity material of the rigid supporting part comprises aluminum. In particular, the use of aluminum enables the rigid supporting part to be produced simply and in specific shapes so as to be able to hold electrical and/or electronic components, while offering thermal conductivity characteristics at least equal to those expected according to the invention. Alternatively, without departing from the context of the invention, the rigid supporting part can comprise, at least in part, extruded graphite or other extruded materials, such as extruded aluminum alloys, as long as these exhibit high thermal conductivity in line with what is expected.

According to a feature of the invention, the rigid supporting part is made so as to be electrically insulating. This electrically insulating feature can be achieved in particular by a specific surface treatment, for example by anodizing the aluminum, or by adding an insulating material between the electrical and/or electronic components and the supporting part. In particular, the material chosen for the supporting part can consist of an aluminum alloy, the alloying elements being chosen to increase the electrical resistivity of the rigid supporting part. By way of non-limiting example, since all aluminum series can be used, the material chosen can in particular consist of an aluminum alloy corresponding to a 1000 series, a 3000 series, or a 6000 series.

According to the invention, the material(s) chosen to form the rigid supporting part can optimally diffuse the heat and/or cold generated by the at least one thermal regulation component while electrically insulating the at least one electrical and/or electronic component housed in the rigid supporting part. Such a material can, in particular, be aluminum nitride, which combines good thermal conductivity with electrical insulation.

According to a feature of the invention, the rigid supporting part comprises a plurality of receiving cavities. It is thus understood that each of the receiving cavities of the rigid supporting part is able to receive a separate electrical and/or electronic component. It is also understood that each of the electrical and/or electronic components housed in each of the receiving cavities of the rigid supporting part is separated by the high thermal conductivity material that said rigid supporting part comprises.

According to a feature of the invention, the plurality of receiving cavities of the rigid supporting part are arranged in a matrix. More specifically, the receiving cavities of the plurality of receiving cavities are arranged in such a way that they are aligned along at least two longitudinal straight lines that are parallel and separate from one another. According to a particular arrangement, the matrix of receiving cavities has an offset arrangement, with the receiving cavities aligned along one of the longitudinal straight lines which are longitudinally offset with respect to the receiving cavities aligned along an adjacent longitudinal straight line. The advantage of such an offset feature is that it provides an even amount of high-thermal-conductivity material between each of the receiving cavities of the rigid supporting part. This makes it possible to uniformly distribute heat and/or cold to each of the battery cells, and also to limit the diffusion of heat from one battery cell to another.

According to a feature of the invention, the receiving cavity opens on either side of the rigid supporting part. The receiving cavity extends into the rigid supporting part in a vertical direction of said rigid supporting part, the receiving cavity then opening vertically on either side of the rigid supporting part.

The rigid supporting part can be produced, for example, by an extrusion process, which makes it possible to form through receiving cavities, i.e. cavities opening out on either side of said rigid supporting part.

According to a feature of the invention, the thermal regulation component is arranged in contact with the rigid supporting part. More precisely, the thermal regulation component is arranged directly in contact with the rigid supporting part, i.e. without any intermediate element between them. The advantage of such a feature is that it makes it possible to limit energy loss between the thermal regulation component and the rigid supporting part.

A first face and a second face of the rigid supporting part are defined, opposite each other in the vertical direction of said rigid supporting part. It is then understood that the at least one receiving cavity opening out on either side of the rigid supporting part is open at the level of the first face and the second face of said rigid supporting part.

A peripheral zone of the rigid supporting part is also defined, said peripheral zone extending such that it vertically connects the first face and the second face of the rigid supporting part.

The at least one thermal regulation component is in contact with the rigid supporting part and can more particularly be in contact with one of the first face and/or the second face of the rigid supporting part, or in contact with its peripheral zone.

According to one feature of the invention, the at least one thermal regulation component is a heating element. The heating element can, for example, take the form of a resistive element or a plate for circulating a heating fluid, which can be a conventional heat transfer fluid, glycol water or oil. In particular, the heating element can take the form of a flexible strip comprising resistive elements and arranged in contact with the peripheral zone. Such a heating element in the form of a flexible strip advantageously makes it possible to follow the contours of the rigid supporting part and thus surround the electrical and/or electronic components, extending around the entire periphery of the rigid supporting part, at the level of its peripheral zone.

According to one feature of the invention, the at least one thermal regulation component is a cooling system. The cooling system can take the form of a plate through which a cooling fluid circulates, this cooling fluid being a cooling liquid or heat-transfer liquid such as glycol water, or a refrigerant fluid such as 1234yf, 134a or the like. In particular, the plate of the cooling system can be arranged in contact with one of the first face or the second face of the rigid supporting part in such a way that said plate participates in holding the at least one electrical and/or electronic component in the at least one receiving cavity of the rigid supporting part.

According to a feature of the invention, the heat management device comprises at least a first thermal regulation component and a second thermal regulation component respectively forming the heating element and the cooling system positioned in contact with separate parts of the rigid supporting part. More particularly, the first thermal regulation component is arranged in contact with the peripheral zone of the supporting part and the second thermal regulation component is arranged in contact with one of the faces of the rigid supporting part.

According to one feature of the invention, the thermal regulation component comprises at least one fluid circulation duct. The fluid can then be a cooling fluid or a heating liquid. The thermal regulation component can comprise microfibers, with at least one of the microfibers forming the at least one fluid circulation duct.

According to a feature of the invention, at least one heat-conducting interface is arranged in the at least one receiving cavity, the heat-conducting interface being intended to be arranged between the rigid supporting part and the electrical and/or electronic component. The function of the heat-conducting interface is in particular intended to limit the presence of air between the electrical and/or electronic component and the rigid supporting part at the level of the receiving cavity and hence improve the exchange of heat between the rigid supporting part and the electrical and/or electronic component. The heat-conductive interface can then take the form of a flexible laminated graphite sheet ensuring contact between the electrical and/or electronic component and the rigid supporting part.

The invention also concerns an electronic system comprising at least one electrical and/or electronic component and a heat management device according to any one of the preceding features.

The electronic system can be, in particular, a computer server or an electrical energy storage system, such as a battery, for a motor vehicle.

In the latter case, the invention relates to a battery comprising at least one battery cell and at least one heat management device as previously mentioned.

According to a feature of the invention, the at least one electrical and/or electronic component and the heat-conducting interface are arranged in the at least one receiving cavity of the rigid supporting part.

The invention also relates to a method for assembling an electronic system according to the preceding features, during which, in a step of inserting the electrical and/or electronic components into the receiving cavities, the electrical and/or electronic component is previously surrounded by the heat-conducting interface and the assembly formed by the electrical and/or electronic component and the heat-conducting interface is inserted into the receiving cavity of the rigid supporting part.

In such an assembly method, the assembly formed by the electrical and/or electronic component and the heat-conducting interface is force-fitted into the receiving cavity of the rigid supporting part, so that said assembly can be held within the receiving cavity without the need for any additional parts. In addition, the arrangement of the heat-conducting interface between the rigid supporting part and the electrical and/or electronic component makes it possible to limit the presence of air between them, so that heat exchange between them is optimal.

According to a feature of the invention, during the method for assembling the electronic system, first of all a positioning step of the thermal regulation component is carried out, during which the at least one thermal regulation component is arranged against one of the first face or the second face of the rigid supporting part, then the insertion step is carried out, during which the electrical and/or electronic component is inserted into one of the cavities of the rigid supporting part in such a way that said assembly is in abutment against the thermal regulation component. It is thus understood that the electrical and/or electronic component is inserted into the receiving cavity of the rigid supporting part at the level of the face opposite to the face of said rigid supporting part against which the thermal regulation component is arranged. In this context, as previously mentioned, it is possible to insert the assembly formed by the electrical and/or electronic component and the heat-conducting interface into one of the cavities of the rigid supporting part.

### BRIEF DESCRIPTION OF THE DRAWINGS

Further features, details and advantages of the invention will become more clearly apparent from reading the description given below by way of indication, with reference to the drawings, in which:

FIG. 1 is a general view of an electronic system comprising a heat management device according to the invention and a plurality of electrical and/or electronic components;

FIG. 2 is a top view of a rigid supporting part of the heat management device of FIG. 1, showing a plurality of receiving cavities respectively configured to receive one of the electrical and/or electronic components; and

FIG. 3 is an exploded view of part of the electronic system of FIG. 1, showing the rigid supporting part of FIG. 2, the plurality of electrical and/or electronic components and at least one heat-conducting interface.

### DETAILED DESCRIPTION OF THE INVENTION

It should first of all be noted that, while the figures set out the invention in detail for the implementation thereof, these figures can of course be used to better define the invention, where appropriate. It should also be noted that these figures set out only examples of ways in which the invention can be embodied. Finally, the same reference signs designate the same elements in all figures.

In the description below, a heat management device will be described in more detail for an electronic system in the form of a motor vehicle battery with electrical and/or electronic components in the form of battery cells. It should however be noted that the following description can apply to electronic systems of another type such as computer servers for example.

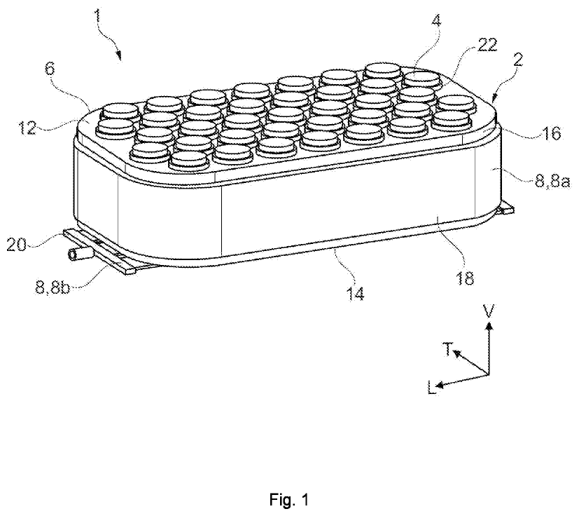

FIG. 1 illustrates an electronic system 1 in the form of an electrical storage device 1, otherwise known as a battery 1, for a vehicle. The electrical storage device 1 comprises at least one heat management device 2 according to the invention and at least one battery cell 4. In the illustrated example of the invention, the electrical storage device comprises a plurality of battery cells 4, here numbering thirty-nine, without this being limiting to the invention. The function of the heat management device 2 is in particular to regulate the temperature of the battery cells 4 both during operation and start-up of the vehicle. Depending on configuration of the heat management device, this can either serve to cool the battery cells 4 during operation of the electrical storage device 1 in order for example to avoid overheating phenomena which can in the long-term damage the electrical storage device 1, and/or pre-heat the battery cells 4 before start-up of the vehicle. The thermal management device 2 therefore allows optimisation of use of the electrical storage device 1 by limiting its deterioration, and consequently that of the battery cells 4. The heat management device 2 comprises at least one rigid supporting part 6 and at least one thermal regulation component 8.

The rigid supporting part 6 comprises at least one receiving cavity 10 able to house one of the battery cells 4. The receiving cavity 10 then forms a housing, here cylindrical with circular cross-section, in order to have a complementary shape to that of the battery cells 4 to be housed in the receiving cavity 10, the battery cells 4 here also being cylindrical. In the illustrated example of the invention, the main extent axis of the receiving cavity is parallel to the vertical direction V of the rigid supporting part 6. More particularly, the receiving cavity 10 is open on either side of the rigid supporting part 6 along its vertical direction V, i.e. the receiving cavity 10 is open to the external environment of the rigid supporting part 6 in its vertical direction V.

In an example of the invention, the rigid supporting part can be made by an extrusion process allowing forming of the through receiving cavity, i.e. which opens on either side of said rigid supporting part.

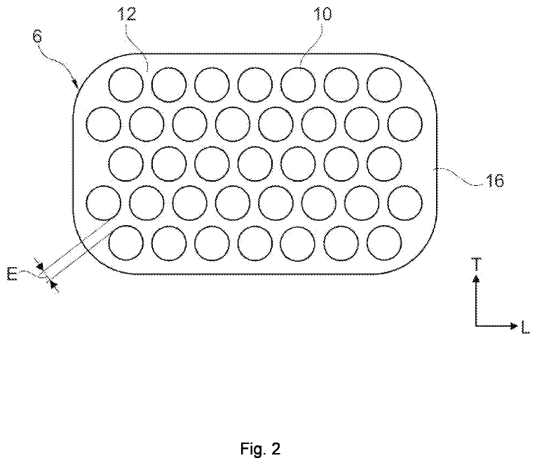

As shown in FIG. 2, the rigid supporting part 6 comprises a plurality of receiving cavities 10 as defined above. In the example illustrated, the receiving cavities 10 are arranged to be aligned along at least two separate longitudinal straight lines perpendicular to the vertical direction V of the rigid supporting part 6. It is understood that the rigid supporting part 6 thus comprises a plurality of receiving cavities 10 arranged in a matrix pattern. More particularly, in this example, the receiving cavities 10 aligned along one of the longitudinal straight lines are arranged offset to the receiving cavities 10 aligned along the other longitudinal straight line. The advantage of the offset arrangement of the receiving cavities to one another is that it allows a sufficient thickness of the material of high thermal conductivity of the rigid supporting part to ensure the thermal regulation of the battery cells. In other words, a minimum mutual spacing E of the battery cells, measured between two adjacent battery cells, is defined, the spacing E between two adjacent battery cells making it possible to avoid the transfer of heat from one battery cell to another.

As can be seen in FIG. 1, the at least one thermal regulation component 8 is arranged in contact with the rigid supporting part 6. More particularly, a first face 12 and a second face 14 of the rigid supporting part 6 are defined, opposite each other along the vertical direction V of said rigid supporting part 6. It is then understood that each of the aforementioned receiving cavities 10 is open at the level of the first face 12 and the second face 14 of the rigid supporting part 6. At least one peripheral zone 16 of the rigid supporting part 6 is also defined which extends around the latter, moreover in such a way that it vertically connects the first face 12 and the second face 14 of the rigid supporting part 6.

In this context, the at least one thermal regulation component 8 is arranged in contact with one of the faces of the rigid supporting part and/or the peripheral zone of said rigid supporting part. More precisely, the at least one thermal regulation component 8 is arranged directly in contact with one of the faces 12, 14 and/or the peripheral zone 16 of the rigid supporting part 6, so that no intermediate element is arranged between the thermal regulation component 8 and the rigid supporting part 6.

The at least one thermal regulation component 8 is able to modify the temperature of the battery cells 4 carried by the rigid supporting part 6. In other words, the thermal regulation component 8 is able to heat and/or cool the battery cells 4 without requiring contact with them. The advantage of such a feature is that a single thermal regulation component 8 can be used to heat and/or cool all the battery cells 4.

To be more precise, thermal regulation of the battery cells 4 is achieved by diffusion of the heat and/or cold generated by the thermal regulation component 8 to the battery cells 4, through the rigid supporting part 6. In other words, the rigid supporting part 6 ensures the diffusion of the heat and/or cold to the battery cells 4.

For this purpose, the rigid supporting part 6 according to the invention is made of a material with high thermal conductivity. A material with high thermal conductivity means that, at 20° C., the thermal conductivity of the material with high thermal conductivity is at least 120 W/m/K. In this way, the material with high thermal conductivity increases the diffusion performance of the heat and/or cold generated by the at least one thermal regulation component 8, so that they are transmitted more quickly and more efficiently to the battery cells 4 housed in the rigid supporting part 6, and so that the thermal regulation, whether heating or cooling, is as homogeneous as possible.

By way of example, the material with high thermal conductivity can comprise, at least in part, aluminum with a thermal conductivity of the order of 237 W/m/K at 20° C., possibly mixed with other materials which can have a lower thermal conductivity of their own, provided that the alloy thus formed has a thermal conductivity of at least 120 W/m/K at 20° C.

It should also be noted that the material with high thermal conductivity chosen to form the rigid supporting part is associated with an electrically insulating layer, whether this layer is produced by a surface treatment of the material or by the addition of a layer of insulating material, in order to electrically insulate the battery cells 4, at least from the thermal regulation component 8.

According to the example shown in FIG. 1, the heat management device 2 comprises two different thermal regulation components, including a first thermal regulation component 8a and a second thermal regulation component 8b. Each of the first thermal regulation component 8a and the second thermal regulation component 8b is then arranged in contact with the rigid supporting part 6, against separate parts thereof. More precisely, and according to the example shown, the first thermal regulation component 8a is arranged in contact with the peripheral zone 16 and the second thermal regulation component 8b is arranged in contact with the second face 14 of the rigid supporting part 6. The first thermal regulation component 8a forms a heating element 18 and the second thermal regulation component 8b forms a cooling system 20.

The first thermal regulation component 8a forming the heating element 18 can take the form of a flexible strip 18a comprising resistive elements, said flexible strip 18a being able to follow the contours of the peripheral zone 16 of the rigid supporting part 6. The resistive elements of the flexible strip 18a each comprise a free end which protrudes from said flexible strip 18a to enable their connection to an electrical supply network. According to an advantageous embodiment illustrated in FIG. 1, the flexible strip 18a forming the first thermal regulation component 8a is in contact with the entire peripheral zone 16 of the rigid supporting part 6, so that it completely surrounds the rigid supporting part and the battery cells carried by this supporting part. In this way, the diffusion of calories generated by said flexible strip 18a and enable uniform diffusion of calories within the rigid supporting part 6 and therefore uniform heating of each of the receiving cavities 10.

According to a first alternative of the invention, the first thermal regulation component 8a can take the form of the flexible strip 18a comprising at least microfibers in place of the aforementioned resistive elements. In such a configuration of the first thermal regulation component 8a, ends of the microfibers extend outside the flexible strip 18a so that said ends are fluidly connected to a fluid supply source which is adapted to supply a heating fluid within said microfibers.

According to other alternatives of the invention, the first thermal regulation component can be formed by one or more rigid plates arranged on a part of the peripheral zone of the rigid supporting part. In this context, the at least one rigid plate can be a resistive plate or a plate for circulating a heating fluid.

The second thermal regulation component 8b forming the cooling system 20 can take the form of a cooling fluid circulation plate 20a, comprising at least one cooling fluid circulation duct. Here, the cooling fluid circulation plate 20a is arranged in contact with the second face 14 of the rigid supporting part 6. When the battery is installed in its operating position in the vehicle, this second face 14 forms an underside facing the ground on which the vehicle is travelling. In this context, the second face 14 forms a means of holding the at least one battery cell 4 housed in one of the receiving cavities 10 of the rigid supporting part 6, along the vertical direction V of the latter, when, as illustrated in the figures, the receiving cavities are through-cavities and open onto this second face 14.

It should be noted that an advantageous embodiment has just been described with a flexible heating element which can be arranged continuously around the circumference of the peripheral zone and ensures uniform preheating of the battery, and with a rigid cooling element which is arranged below the rigid supporting part at an equal distance from the lower end of each battery cell and can form an abutment wall to fix the position of the cells.

While this embodiment is particularly advantageous, it should be noted that the arrangement of the thermal regulation component could be different without departing from the context of the invention, since their presence combined with the rigid supporting part made of a highly thermally conductive material makes it possible to optimize heat exchange with the battery cells held in position by the supporting part.

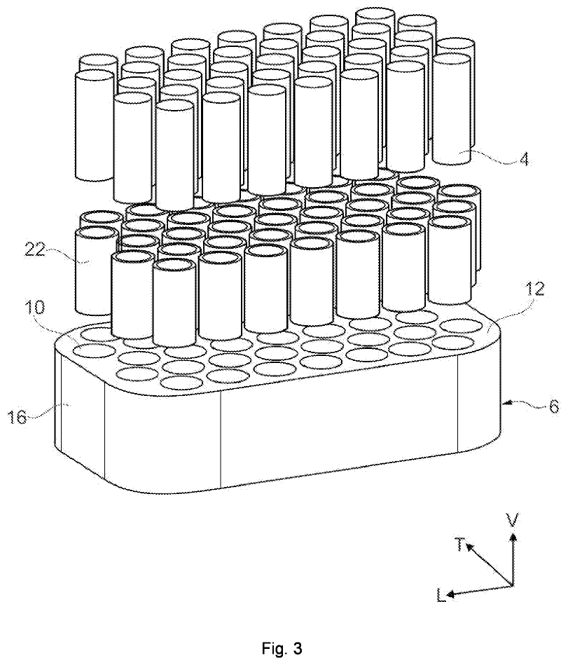

As shown in FIGS. 1 and 3, the heat management device 2 according to the invention comprises at least one heat-conducting interface 22. More specifically, the heat-conducting interface 22 is arranged in one of the receiving cavities 10 of the rigid supporting part 6 and such that it is located between the rigid supporting part 6 and the battery cell 4. The function of the heat-conducting interface 22 is then to facilitate the transmission of heat and/or cold by contact between the rigid supporting part 6 and the battery cell 4, in particular by limiting the air present between these two parts, the presence of air having the effect of thermally insulating the battery cell 4.

The heat-conducting interface 22 can comprise a resistive element, such as a nickel foil, connected to a power supply. In this way, the heat-conducting interface is capable of transmitting calories to the battery cell 4, with said resistive element housed in the heat-conducting interface forming the first thermal regulation component.

A method for assembling the battery 1 according to the invention will now be described by means of FIGS. 1 and 3. It should be borne in mind that, in the description of the following method example, not all the steps of the method for assembling the battery 1 will be described, and that only the steps relating to the heat management device 2 according to the invention will be described in detail.

The method for assembling such a battery 1 according to the invention comprises at least two steps, including a step of inserting the battery cells 4 into the receiving cavities 10, and a step of positioning the thermal regulation component 8 in contact with the rigid supporting part 6. These at least two steps can then be carried out in different orders.

According to a first exemplary embodiment of the method, the first step is to position the thermal regulation component 8. The first thermal regulation component 8a and the second thermal regulation component 8b are positioned, respectively, against the peripheral zone 16 and the second face 14 of the rigid supporting part 6. The next step is then to insert the battery cells 4 into the receiving cavities 10 of the rigid supporting part 6.

In this context, the insertion step can comprise a sub-step of arranging the heat-conducting interface 22 around the battery cell 4, during which the heat-conducting interface 22 is wrapped around the battery cell 4.

Then, in a further sub-step of force-fitting, the assembly formed by the battery cell 4 and the heat-conducting interface 22 is placed in one of the receiving cavities 10 of the rigid supporting part 6. More particularly, the assembly formed by the battery cell 4 and the heat-conducting interface 22 is inserted into one of the receiving cavities 10 at the level of the first face 12 of the rigid supporting part 6 until said assembly is in abutment against the second thermal regulation component 8b positioned against the second face 14 of said rigid supporting part 6.

It is therefore understood that in this assembly method, the battery cell 4 is held in the receiving cavity 10 at least by the second thermal regulation component 8b when it is positioned against the second face 14 of the rigid supporting part 6.

According to a second exemplary embodiment of the method, the first step is to insert the battery cells 4 into the receiving cavities 10 of the rigid supporting part 6. Of course, it is understood that this step of inserting the battery cells 4 can comprise the two sub-steps mentioned above, during which the heat-conducting interface 22 is arranged around the battery cell 4, and then the assembly formed by the battery cell 4 and the heat-conducting interface 22 is forcibly inserted into one of the receiving cavities 10 of the rigid supporting part 6.

Next is the step of positioning the thermal regulation component 8, during which the first thermal regulation component 8a and the second thermal regulation component 8b are placed, respectively, against the peripheral zone 16 and the second face 14 of the rigid supporting part 6, as described above.

The advantage of the invention as just described is that it enables the thermal regulation of at least one electrical and/or electronic component, such as a battery cell, to be improved by means that are simple to implement and therefore inexpensive.

The invention is not, however, limited exclusively to the embodiments and example methods described and illustrated, and also applies to any means or configurations, and any combination of such means or configurations, enabling the thermal regulation of at least one electrical and/or electronic component to be improved in an equivalent manner, as soon as a combination between a thermal regulation component and a rigid part forming a support for an electrical and/or electronic component is implemented.

What is claimed is:

1. A heat management device for at least one electrical and/or electronic component, comprising at least one thermal regulation component, a rigid supporting part with at least one receiving cavity for receiving the at least one electrical and/or electronic component, with the rigid supporting part being made of a material with high thermal conductivity.

2. The heat management device as claimed in claim 1, wherein the high thermal conductivity material of the rigid supporting part includes aluminum.

3. The heat management device as claimed in claim 1, wherein the at least one thermal regulation component is arranged in contact with the rigid supporting part.

4. The heat management device as claimed in claim 1, wherein at least one thermal regulation component is a heating element.

5. The heat management device as claimed in claim 1, wherein the at least one thermal regulation component is a cooling system.

6. The heat management device as claimed claim 1, wherein the at least one thermal regulation component includes at least a first thermal regulation component and a second thermal regulation component forming, respectively, a heating element and a cooling system positioned in contact with separate parts of the rigid supporting part.

7. The heat management device as claimed in claim 1, wherein at least one heat-conducting interface is arranged in the at least one receiving cavity, the at least one heat-conducting interface being configured to be arranged between the rigid supporting part and the at least one electrical and/or electronic component.

8. An electronic system comprising at least one electrical and/or electronic component and at least one heat management device including at least one thermal regulation component, a rigid supporting part with at least one receiving cavity for receiving the at least one electrical and/or electronic component, with the rigid supporting part being made of a material with high thermal conductivity.

9. The electronic system as claimed in claim 8, wherein at least one heat-conducting interface is arranged in the at least one receiving cavity, the at least one heat-conducting interface being configured to be arranged between the rigid supporting part and the at least one electrical and/or electronic component, wherein the at least one electrical and/or electronic component and the at least one heat-conducting interface are arranged in the at least one receiving cavity of the rigid supporting part.

10. A method for assembling an electronic system, including at least one electrical and/or electronic component and at least one heat management device including at least one thermal regulation component, a rigid supporting part with at least one receiving cavity for receiving the at least one electrical and/or electronic component, with the rigid supporting part being made of a material with high thermal conductivity, wherein at least one heat-conducting interface is arranged in the at least one receiving cavity, the at least one heat-conducting interface being configured to be arranged between the rigid supporting part and the at least one electrical and/or electronic component, wherein the at least one electrical and/or electronic component and the at least one heat-conducting interface are arranged in the at least one receiving cavity of the rigid supporting part, comprising inserting the at least one electrical and/or electronic components into the receiving cavities, wherein the at least one electrical and/or electronic component is previously surrounded by the at least one heat-conducting interface and the assembly formed by the at least one electrical and/or electronic component and the at least one heat-conducting interface is inserted into the receiving cavity of the rigid supporting part.
